(19) United States
(12) Patent Application Publication
(10) Pub. No.: US 2020/0338596 A1
(43) Pub. Date: Oct. 29, 2020

(54) APPARATUS AND METHOD FOR THE SEPARATION OF LIGHT-WEIGHT DEBRIS FROM FLOWABLE MATERIAL STREAMS

(71) Applicant: Astec Industries, Inc., Chattanooga, TN (US)

(72) Inventors: Paul J. Clark, Eugene, OR (US); Kim Toney, Oakridge, OR (US); Richard Ricker, Eugene, OR (US); Don Muth, Cottage Grove, OR (US)

(73) Assignee: Astec Industries, Inc., Chattanooga, TN (US)

(21) Appl. No.: 16/859,608

(22) Filed: Apr. 27, 2020

Related U.S. Application Data
(60) Provisional application No. 62/839,245, filed on Apr. 26, 2019.

(51) Int. Cl. B07B 4/02; B07B 11/06

(52) U.S. Cl. CPC B07B 4/02; B65G 19/22; B07B 11/06

(57) ABSTRACT

An apparatus for removing lightweight debris from a debris-contaminated stream of heavier material. The apparatus includes an enclosed chamber having a material inlet, a chute having a free portion through which the stream can freely fall due to gravity, and a material outlet positioned below the chute. A material stream flows into the chamber via the inlet and then a portion of the stream falls through the free portion and exits the chamber via the outlet. An airflow pathway guides airflows into the chamber via an airflow inlet and out of the chamber via an airflow outlet. An airflow flowing through the airflow pathway that separates a first portion of the debris-contaminated stream from a heavier portion of the debris-contaminated stream. The airflow then carries the first portion out of the chamber via the airflow outlet.

### CROSS-REFERENCE TO RELATED APPLICATION

This application claims the benefit of U.S. Provisional Patent Application No. 62/839,245, filed on Apr. 26, 2019, and entitled APPARATUS AND METHOD FOR THE SEPARATION OF LIGHT-WEIGHT DEBRIS FROM FLOWABLE MATERIAL STREAMS, which is incorporated herein by reference in its entirety.

### FIELD OF THE INVENTION

The invention relates generally to removal of lightweight debris from a stream of particulate or flowable material. More particularly, this invention relates to a method and apparatus for using a stream of air and a circulating belt to remove lightweight debris from a stream of flowable material.

### BACKGROUND OF THE INVENTION

Processing pre-compostable material, such as green waste, food waste, animal waste, wood waste, construction scraps and waste, products of demolition, etc. is made much more difficult when that material is contaminated by debris and non-biodegradable materials. Often, the debris includes plastic films, plastic bags, and other similar light-weight materials that are non-compostable. These types of debris are considered a contaminate in green waste that is being processed for landscaping materials, such as compost, mulch, and recycled materials, or for other types of processed materials. Plastic films and bags are equally problematic in commodity recycling of hard plastic, paper, metal, and glass. The presence of high quantities of plastic film, plastic bags and other similar debris in composted or recycled materials often prevents those materials from being sold in the marketplace.

Accordingly, what is needed is an apparatus and method for removing unwanted lighter-weight debris from flowable material streams while maximizing the recovery of wanted heavier-weight materials from those streams.

### NOTES ON CONSTRUCTION

The use of the terms “a”, “an”, “the” and similar terms in the context of describing the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

Terms concerning attachments, coupling and the like, such as “attached”, “connected” and “interconnected”, refer to a relationship wherein structures are secured or attached to one another either directly or indirectly through intervening structures, as well as both moveable and rigid attachments or relationships, unless otherwise specified herein or clearly indicated as having a different relationship by context. The term “operatively connected” is such an attachment, coupling or connection that allows the pertinent structures to operate as intended by virtue of that relationship.

The use of any and all examples or exemplary language (e.g., “such as” and “preferably”) herein is intended merely to better illuminate the invention and the preferred embodiments thereof, and not to place a limitation on the scope of the invention. Nothing in the specification should be construed as indicating any element as essential to the practice of the invention unless so stated with specificity.

The term “debris” as it is used in describing various aspects of the invention is used merely to denote a first component of a stream of flowable material that is lighter in weight than a second component of the stream. The debris (i.e., the first component forming the flowable stream) is sufficiently light enough that it may be carried out of the stream of flowable material (i.e., away from the second component) by an airflow passing across the stream of flowable material.

### BRIEF SUMMARY OF THE INVENTION

The above and other needs are met by an apparatus for use in removing debris from a debris-contaminated stream of flowable material. The apparatus includes an enclosed chamber having a material inlet, a chute having a free portion extending below the material inlet through which the debris-contaminated stream can freely fall due to gravity, and a material outlet that is positioned below the chute. The debris-contaminated stream of flowable material is provided to the chamber via the material inlet and then at least a portion of the stream of flowable material falls through the free portion of the chute and exits the chamber via the material outlet. The apparatus further includes an airflow pathway that guides airflows through the chamber via an airflow inlet and out of the chamber via an airflow outlet. Air flows through the airflow pathway and separates a first portion of the debris-contaminated stream from a second, heavier portion of the debris-contaminated stream. The first portion is then carried away from the second, heavier portion by the airflow out of the chamber via the airflow outlet.

The apparatus further includes a circulating belt that is disposed in the chamber in a first position adjacent the chute and also in a second portion adjacent the airflow outlet. The circulating belt is configured to carry debris from the chute to the airflow outlet. When an airflow is provided through the chamber via the airflow pathway, debris falling with the flowable material through the chute is carried away from the flowable material by the airflow and into contact with the circulating belt at the first position in the chamber adjacent the chute. That debris is then carried by the circulating belt to the second position that is adjacent the airflow outlet. Finally, the debris is carried by the airflow away from the circulating belt and out of the chamber via the airflow outlet.

Another preferred embodiment of the invention includes a belt apparatus for use on a circulating debris-removal apparatus. The circulating debris-removal apparatus has rollers around which the belt apparatus circulates, an airflow flowing into a first side of the debris-removal apparatus through the circulating belt apparatus and out of a second side of the debris-removal apparatus through the circulating belt apparatus. A debris-contaminated stream of flowable material falls due to gravity adjacent the first side of the debris-removal apparatus such that debris falling with the flowable material is carried away from the flowable material by the airflow and into contact with the belt apparatus and is then carried away from the belt apparatus by the airflow on the second side of the debris-removal apparatus. The belt apparatus includes a flexible belt surface formed into a closed loop for placement on and for circulation about the rollers. A plurality of elongate fingers extend outwards across substantially the entire outward-facing surface of the circulating belt surface. Finally, a plurality of apertures are formed in the circulating belt surface between adjacent elongate fingers that are configured to allow air to pass through the circulating belt surface.

A method for removing debris from a debris-contaminated stream of flowable material according to the present invention first requires providing a debris separation apparatus. The debris separation apparatus has a chamber with a material inlet, a chute having at least a portion extending below the material inlet, a material outlet, an airflow inlet, an airflow outlet, and a circulating belt that is disposed in the chamber in a first position adjacent the chute and in a second position adjacent the airflow outlet. The method further requires feeding a stream of debris-contaminated flowable material into the chamber via the material inlet such that at least a portion of the flowable material falls through the chute and out of the chamber via the material outlet. While the flowable material is falling through the chute, an airflow enters the chamber via the airflow inlet, is directed across the chute and through the falling flowable material towards the first position of the belt disposed adjacent the chute such that debris entrained with the stream of flowable material is blown out of the stream of falling flowable material and into contact with the belt, and exits the chamber via the airflow outlet. Debris blown into contact with the belt by the airflow is captured by the belt. The belt circulates and carries captured debris to the second position adjacent the airflow outlet. Finally, captured debris located on the belt adjacent the airflow outlet is blown out of the chamber via the airflow outlet by the airflow.

### BRIEF DESCRIPTION OF THE DRAWINGS

The presently preferred embodiments of the invention are illustrated in the accompanying drawings, in which like reference numerals represent like parts throughout, and in which:

FIG. 1 is side elevation view depicting an apparatus having a belt track positioned in an airflow for removing debris from a debris-contaminated stream of flowable material according to a first embodiment of the present invention;

FIG. 2 is a front perspective view depicting the belt track of FIG. 1 having a circulating belt extending around rollers and also showing a rigid backing plate lying behind the circulating belt;

FIG. 3 is a front view of a portion of a circulating belt taken along line “3-3” of FIG. 1 including a cutaway section to show a rigid backing plate lying behind the circulating belt; and

FIG. 4 is a sectional view taken from line “4-4” of FIG. 3.

### DESCRIPTION OF THE PREFERRED EMBODIMENTS OF THE INVENTION

This description of the preferred embodiments of the invention is intended to be read in connection with the accompanying drawings, which are to be considered part of the entire written description of this invention. The drawings are not necessarily to scale, and certain features of the invention may be shown exaggerated in scale or in somewhat schematic form in the interest of clarity and conciseness.

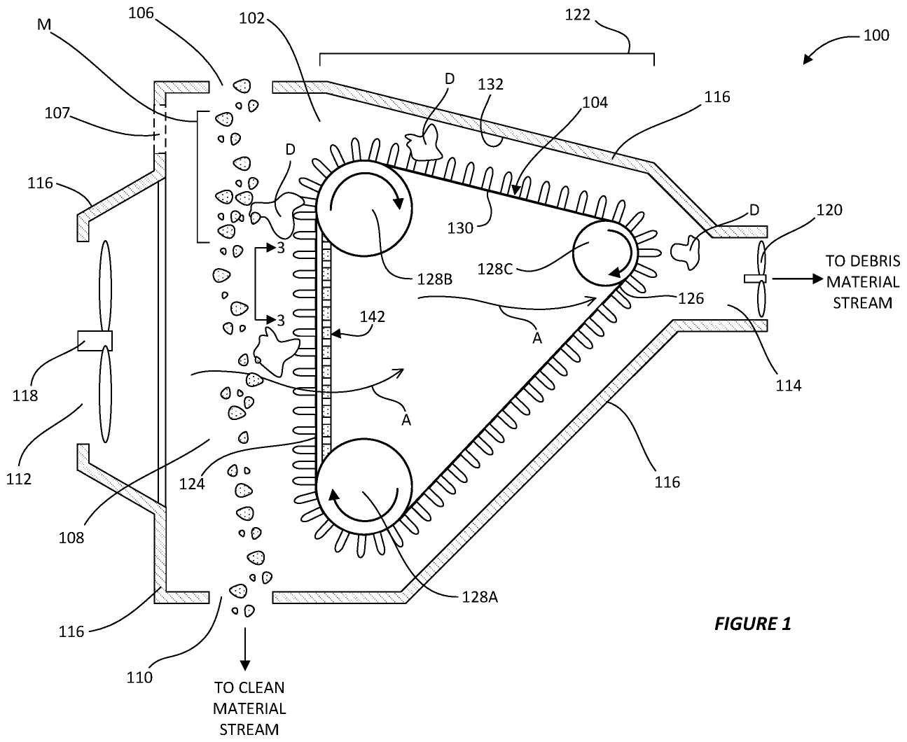

Referring now to FIGS. 1-4, there is provided an apparatus 100 for use in removing lightweight debris D (e.g., plastic films, plastic bags, etc.) from a debris-contaminated stream of comparatively heavier flowable material M (e.g., mulch, compost, etc.) according to an embodiment of the present invention. As more fully described herein, the apparatus 100 includes generally an enclosed chamber 102 (a cross-sectional view of said chamber is depicted in FIG. 1), a circulating belt apparatus 104 located within the chamber and an airflow pathway that is configured to direct airflows A through the chamber and across the belt. When the apparatus 100 is in operation, a stream of flowable material M that includes lightweight debris D is fed into the chamber 102 and at least a portion of the stream of flowable material M falls through a free portion of the chamber, due to gravity, and then exits the chamber to a clean material stream. To separate the lightweight debris D from the material stream M, an airflow A is first directed across the falling material stream towards the circulating belt apparatus 104. Lightweight debris D is carried by the airflow A out of the falling material stream M and into contact with the circulating belt apparatus 104. The circulating belt apparatus 104 carries lightweight debris D to a second location that is remote from the material stream M, where it is then carried out of the chamber 102 by airflow A that flows away from the circulating belt to a lightweight debris material stream.

As shown best in FIG. 1, from top to bottom, the chamber 102 includes a top material inlet 106, a chute 108 having a free portion extending vertically below the material inlet through which the debris-containing stream of flowable material M may fall, a material outlet 110 that is preferably located below the inlet and the chute. Now, from left to right, the chamber 102 also includes an airflow inlet 112 and an airflow outlet 114. Preferably, the chamber 102 is formed by external walls 116 or some other form of enclosure. The stream of debris-contaminated flowable material M is fed into the chamber 102 via the material inlet 106. In this particular case, the material inlet 106 is located in a top surface of the chamber 102. In other embodiments, material inlet 107 may be located on a side surface of the chamber 102. After being fed through the material inlet 106, the flowable material M then falls through the chute 108, where it is separated from the lightweight debris D according to the invention. Preferably, clean (i.e., substantially free of lightweight debris) flowable material M exits the chamber 102 via the material outlet 110, where it may be collected and transported away.

Additionally, a separate stream of debris D is carried out of the chamber 102 via the outlet 114. An airflow pathway is configured to direct airflows A through the chamber 102, such that the air enters the chamber via the airflow inlet 112 and exits the chamber via the airflow outlet 114. Lightweight debris D that is entrained and falling with the flowable material M down through the chute 108 is caught in the airflow, is carried away from the flowable material, and is then carried out of the chamber 102 via the airflow outlet 114. Airflows A may be generated in the chamber 102 using a first blower device 118 that is preferably located at the airflow inlet 112, a second blower device 120 that is preferably located at the airflow outlet 114, or both. Preferably, the chamber 102 includes a tapered section 122, where the walls 116 of the chamber are tapered towards the airflow outlet 114 and the cross-sectional area of the chamber (along a plane extending into the page) is reduced. This reduction in internal cross-sectional area increases the velocity of the airflow A as the airflow moves left-to-right (as shown in FIG. 1) through the chamber 102 towards the airflow outlet 114, such that the airflow velocity before the tapered section 122 is less than the airflow velocity after the tapered section. The increased velocity of the airflow A assists the circulating belt apparatus 104 in moving lightweight debris D through the chamber 102, including by dislodging debris that becomes stuck in the chamber and ejecting debris from the chamber via the airflow outlet 114.

Lightweight debris D is carried by the airflow A away from falling flowable material M and into contact with the circulating belt apparatus 104 in a first position 124 that is located adjacent the chute 108. The circulating belt apparatus 104 is designed to catch lightweight debris D that comes into contact with the circulating belt apparatus 104 at the first position 124 and to carry that lightweight debris as it circulates to a second position 126 of the circulating belt that is located adjacent the airflow outlet 114. Once the lightweight debris D has been re-located to the second position 126 of the circulating belt apparatus 104, it is carried by the airflow A for a second time. This second time, the airflow A, which is traveling away from the circulating belt apparatus 104, carries the lightweight debris D away from the circulating belt and out of the chamber 102 via the airflow outlet 114 to a debris material stream.

The circulating belt apparatus 104 includes a flexible belt surface that is formed into a closed loop that is sized and configured for circulation about a set of rollers which create a belt track. In certain preferred embodiments, the belt track includes at least three rollers 128A, 128B, 128C, which all rotate the same direction (clockwise, in FIG. 1), and are arranged in the shape of a triangle. Preferably, the first position 124 of the circulating belt apparatus 104 comprises two rollers 128A, 128B of the at least three rollers that are substantially vertically offset from one another. The belt apparatus 104 circulates vertically upwards at the first position 124 over rollers 128A, 128B in a substantially opposite direction of the falling flowable material M falling down the chute 108. The top of the upper roller 128B of the two vertically offset rollers 128 preferably forms an apex of the circulating belt track. In that instance, the third roller 128C is laterally adjacent to and vertically lower than roller 128B. Thus, the circulating belt track includes an upper position 130 between the one roller 128B forming the apex and the laterally offset roller 128C at a downwards slanting angle. In certain embodiments, the rollers 128 have the same diameter. However, in other embodiments, one or more of the rollers 128 have different diameters. In the illustrated embodiment, roller 128C has a smaller diameter than rollers 128A and 128B.

A top portion 132 of the wall forming the inner surface of the chamber 102 that is located directly above the slanted upper position 130 of the belt apparatus 104 is also preferably slanted and generally follows the downward slanting angle of the belt. The slanted angle of the wall portion 132, combined with the direction of the airflow A and belt circulation, encourages lightweight debris D that may come into contact with the top portion 132 of the wall to travel downwards towards the airflow outlet 114. The direction of belt travel also helps to prevent lightweight debris D from falling out of the chamber 102 through material outlet 110. Ideally, lightweight debris D will be blown into contact with the circulating belt apparatus 104 and then be carried out of the chamber 102, as discussed above. However, should that fail to occur and lightweight debris D remains in the chute 108, the debris should be continually thrown upwards due to the direction and speed of belt travel (which also tends to create an upwards airflow that is capable of blowing certain lightweight debris upwards from the bottom of the chamber 102). After being blown back upwards, the lightweight debris D is blown back into contact with the belt apparatus 104 by airflow A. Eventually, the lightweight debris D is carried out of the chamber 102 by the circulating belt apparatus 104 and airflow A, as intended. In some embodiments, a bottom surface of the chamber 102 located below roller 128A and near material outlet 110 may be curved upwards (depicted in FIG. 1 by a dotted line) in order to assist in blowing lightweight debris D upwards and not out of the chamber via the material outlet.

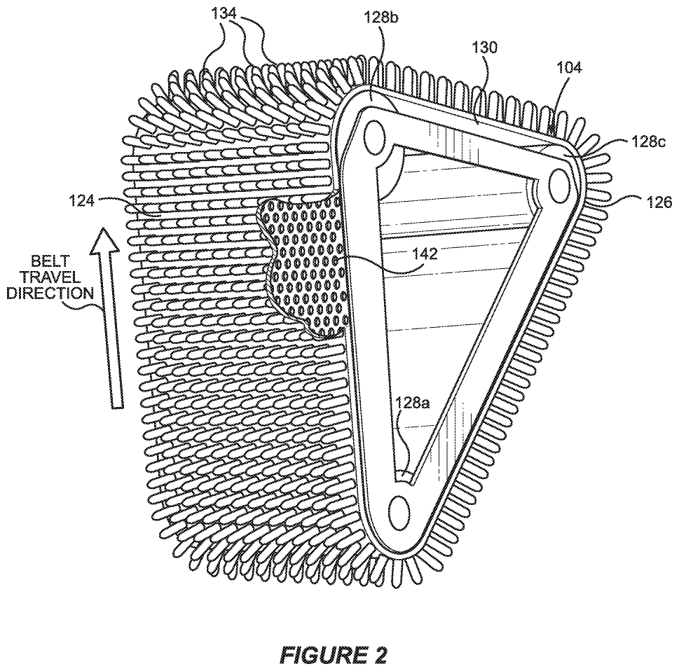

The surface of the circulating belt apparatus 104 may have various features to facilitate carrying lightweight debris D from the first position 124 of the belt to the second position 126 of the belt. In some embodiments, the surface of the belt apparatus 104 may have surface texturing or a surface coating (e.g., a tacky or sticky coating) that provides at least a slight adhesion between the belt and the lightweight debris D that comes into contact with the belt. In certain preferred embodiments, the belt apparatus 104 includes a plurality of elongate fingers 134 that extend outwards from an outward-facing surface 136 of the circulating belt apparatus 104. The fingers 134 are designed to capture falling lightweight debris D that has been blown into contact with the circulating belt apparatus 104 by the airflow A and to then easily release that captured debris when desired. Preferably, the elongate fingers 134 are disposed across substantially the entire outward-facing surface 136 of the circulating belt apparatus 104 (as shown in FIG. 2) in order to maximize the effectiveness of the belt in capturing lightweight debris D.

The circulating belt apparatus 104, including the elongate fingers 134, may be constructed in a variety of ways to augment or improve their debris-holding ability, depending on the nature of their application. For example, the elongate fingers 134 may be rigid or they may be flexible. In some embodiments, the elongate fingers 134 may have a cross section that is uniform in size from end to end. However, in other embodiments, the elongate fingers have a stepped or tapering cross section, with a widest cross section disposed immediately adjacent the outward-facing surface 136 of the circulating belt and a thinnest cross section at a tip 138 of each of the plurality of elongate fingers.

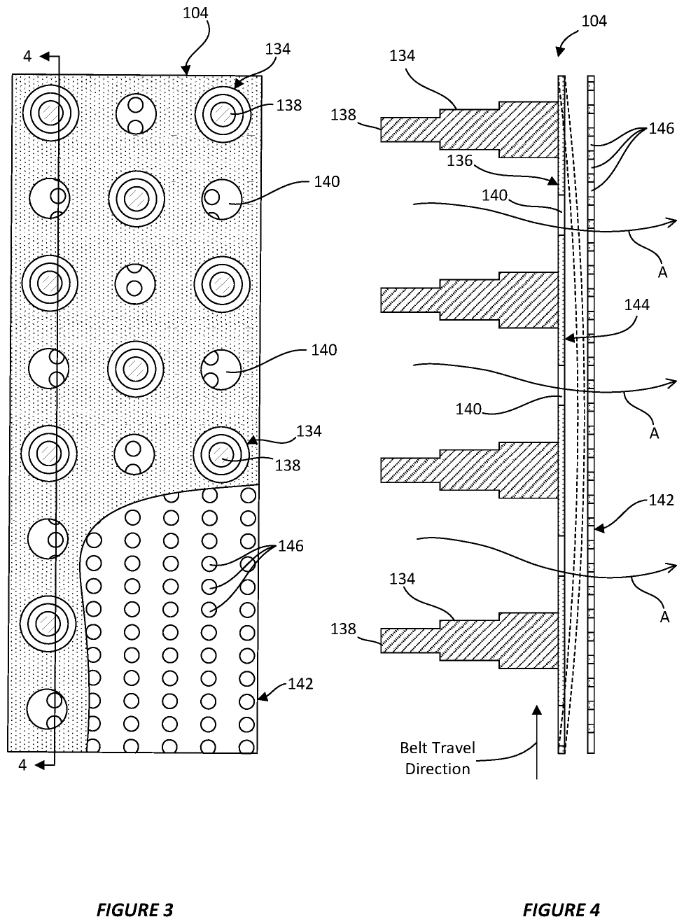

The circulating belt apparatus 104 may be provided with a continuous surface. However, in preferred embodiments, apertures 140 are formed in the belt apparatus 104 in spaces located between adjacent fingers 134, as shown in FIGS. 3 and 4. The apertures 140 are designed to allow airflows A to flow through the belt, including through the belt at the first position 124 and at the second position 126 (see FIG. 1). Having the airflow A flow into the outward-facing surface 136 of the belt apparatus 104 via apertures 140 located at the first position 124 of the belt assists in keeping lightweight debris D held securely to the belt as it circulates vertically towards roller 128B. Having the airflow A flow out through the outward-facing surface 136 of the belt apparatus 104 via apertures 140 located at the second position 126 of the belt assists in carrying lightweight debris D away from the belt and out of the chamber 102 via the airflow outlet 114.

A substantial volume of high-speed airflow may be desired for the apparatus 100 disclosed herein to work effectively. Directing a high volume airflow A directly onto the circulating belt apparatus 104 is likely to cause the belt to experience significant lateral deflection (shown as dashed lines in FIG. 4). Among other things, a substantial or excessive deflection of the belt could cause the tips 138 to collapse inwards towards one another, which might reduce the effectiveness of the fingers 134 to capture and carry lightweight debris D. For that and other reasons, a stationary rigid (or semi-rigid) backing plate 142 may be located at the first position 124 of the circulating belt apparatus 104 and mounted adjacent an inward-facing surface 144 of the circulating belt in order to limit the amount of lateral deflection that the belt experiences. The rigid backing plate 142 may be constructed from a solid material, such as steel plate, etc. However, when airflow A through the circulating belt (as discussed previously) is desired, the rigid backing plate 142 may also be provided with a plurality of apertures 146, perforations, etc. As such, airflow A first passes through the belt apparatus 104 at first position 124 via apertures 140, through the backing plate 142 via apertures 146, and then back through the belt at the second position 126 via apertures 104.

The following illustrates a method of operating the apparatus 100 according to a preferred embodiment. First, belt apparatus 104 is circulated by rollers 128A, 128B, 128C in the direction indicated by the rounded arrows (in FIG. 1) so that the belt moves counter to the direction that flowable material M falls through the chute 108 at the first position 124. Next, an airflow A is generated through the chamber 102. The airflow A may be generated by at least one of a blower device 118 or a second blower device 120. The belt apparatus 104 is provided with apertures 140 that allow the airflow A to pass through the belt at the first position 124 and at the second position 126. A rigid backing plate 142 is placed adjacent to and behind the belt apparatus 104 at the first position 124 in order to limit the lateral deflection of the belt apparatus 104 at the first position. The backing plate 142 is also provided with apertures 146 such that the airflow A also passes through the backing plate.

Once the belt apparatus 104 is circulating and the airflow A is active, a stream of flowable material M including lightweight debris D is fed into the chamber 102 via material inlet 106. The flowable material M falls from the material inlet 106 and down through the chute 108. The chute 108 is located such that falling flowable material M is spaced away from the circulating belt apparatus 104. The flowable material M is heavy enough that it falls straight through the chute 108 and is not affected or only minimally affected by the airflow A. On the other hand, the lightweight debris D is light enough that it is blown out of the falling stream of flowable material M into contact with the circulating belt apparatus 104 at the first position 124. The lightweight debris D is captured by the fingers 134 extending away from the belt apparatus 104. It is then carried upwards over the apex formed by roller 128B, laterally downwards towards roller 128C, and then to the second position 126 of the belt. The captured lightweight debris D is dislodged by the airflow A blowing through the belt apparatus 104 at the second position 126. Captured lightweight debris D might also be dislodged from the belt apparatus 104 by inertia as the belt changes direction over roller 128C. Once dislodged, lightweight debris D is guided out of the chamber 102 via airflow outlet 114. Loose lightweight debris D that is not carried by the belt apparatus 104 may be carried by the airflow A blowing between wall portion 132 and the belt and then out of the chamber 102 via airflow outlet 114.

From the discussion above, it can be seen that one of the key factors in the success of the apparatus 100 in separating flowable material M from debris material D is that those two material streams respond differently to the airflow A. The waste or debris material D will be lighter in weight and the flowable material will be heavier. The characteristics of the airflow A (e.g., number of airflows, velocity, direction, volume) can be adjusted to take advantage of these differences. This could include, for example, adjusting either the first blower device 118, the second blower device 120, or both, such that only lightweight material D (such as waste plastic material) is carried in the debris material stream through airflow outlet 114 and only the heavier, flowable material M falls down as the clean material stream that is discharged through material outlet 110. Ordinarily, the direction of at least a substantial portion of the airflow A through the chamber 102 is substantially horizontal and is orthogonal to the direction of the falling stream of flowable material M through the chute 108. In other cases, however, the direction of the airflow A may be changed (i.e., angled up or angled down) in order to achieve better or different sorting outcomes. Also, the number, velocity or volume of airflows may be adjusted downwards or upwards, including when lighter or heavier materials M and lightweight debris D are passed through the chamber 102. For example, a series of airflows and corresponding circulating belts 104 may be stacked on top of one another along a common chute 108. These streams and belts 104 may have different characteristics (e.g., volume, speed, direction, etc.) in order to sort and separate various elements, such as a first debris stream that is removed by the first airflow and a second (heavier) debris stream, from the falling stream of flowable material M. For example, a first airflow might flow left-to-right (as shown in FIG. 1) and a second airflow that is positioned below the first airflow might flow right-to-left. Lastly, the speed of the belt apparatus 104 may be adjusted in order to modify or optimize the performance of the apparatus 100.

In the cases discussed above, heavy flowable material M is contaminated by lightweight debris material D. By using the above-described apparatus 100, clean flowable material M may be obtained by removing the lightweight debris D. In that case, the flowable material M falls through the chute 108 and out of the material outlet 110, whereas the lightweight debris D is re-directed towards the airflow outlet 114. However, in other cases, a stream of desired material may be lighter in weight than heavier debris contaminating that desired material. This might occur, for example, if the user of the apparatus recycled paper or plastic and that paper or plastic were contaminated with metal or other heavy debris. In that case, the desired material (i.e., paper or plastic in the example above) would be carried by the airflow towards the airflow outlet 114. The heavier debris material (i.e., metal in the example above) would fall through the chute to the material outlet 110.

Although this description contains many specifics, these should not be construed as limiting the scope of the invention but as merely providing illustrations of some of the presently preferred embodiments thereof, as well as the best mode contemplated by the inventor of carrying out the invention. The invention, as described herein, is susceptible to various modifications and adaptations as would be appreciated by those having ordinary skill in the art to which the invention relates.

What is claimed is:

1. An apparatus for removing debris from a debris-contaminated stream of heavier flowable material, the apparatus comprising:
an enclosed chamber having a material inlet, a chute having a free portion extending below the material inlet through which the debris-contaminated stream can freely fall due to gravity, a material outlet that is positioned below the chute, wherein said debris-contaminated stream of flowable material is provided to the chamber via the material inlet and then at least a portion of the stream of flowable material falls through the free portion of the chute and exits the chamber via the material outlet;
an airflow pathway configured to guide airflows through the chamber via an airflow inlet and out of the chamber via an airflow outlet,
a blower for generating an airflow through the airflow pathway, said airflow being configured to separate a first portion of the debris-contaminated stream from a heavier portion of the debris-contaminated stream, wherein the first portion is carried away from the heavier portion by the airflow out of the chamber via the airflow outlet.

2. The apparatus of claim 1 wherein the airflow pathway is configured such that at least a substantial portion of the airflow through the chamber is directed substantially orthogonal to the direction of the falling stream of flowable material through the chute.

3. The apparatus of claim 1 further comprising a tapered section formed in the chamber that tapers towards the airflow outlet such that the airflow velocity before the tapered section is less than the airflow velocity after the tapered section.

4. The apparatus of claim 1 further comprising a circulating belt that is configured so that it moves through at least a first position that is disposed in the chamber adjacent the chute and a second position that is adjacent the airflow outlet, the circulating belt configured to carry debris from the chute to the airflow outlet, wherein, when the airflow is provided through the chamber via the airflow pathway, debris falling with the flowable material through the chute is carried away from the flowable material by the airflow and into contact with the circulating belt in the chamber and out of the chamber via the airflow outlet.

5. The apparatus of claim 4 wherein the circulating belt further comprises a plurality of elongate fingers extending outwards from an outer surface of the circulating belt that are configured to capture falling debris blown into contact with the circulating belt by the airflow.

6. The apparatus of claim 4 wherein the circulating belt further comprises a plurality of apertures formed in the circulating belt that are configured to allow said airflow to pass through the circulating belt such that the airflow passing through the apertures in the belt adjacent the airflow outlet passes through the circulating belt and carries debris on the circulating belt out of the chamber via the airflow outlet.

7. The apparatus of claim 4 wherein said portion of the circulating belt located adjacent the chute moves in a direction substantially opposite the direction of falling flowable material.

8. The apparatus of claim 4 further comprising at least three rollers for carrying the circulating belt in a belt track.

9. The apparatus of claim 8 wherein the three rollers are arranged such that the belt track is substantially triangular in shape.

10. The apparatus of claim 4 further comprising at least three rollers for carrying the circulating belt, including two of the at least three rollers that are vertically offset from one another to form a vertical belt section, wherein the falling stream of flowable material falls adjacent the vertical belt section, and the third roller that is laterally offset from the two vertically offset rollers.

11. The apparatus of claim 10 wherein an upper one of the two vertically offset rollers forms an apex of a circulating belt track formed by the belt.

12. The apparatus of claim 11 wherein the laterally offset roller is adjacent to and is positioned vertically lower than the one roller forming the apex such that at least a portion of the circulating belt track extending between the one roller forming the apex and the laterally offset roller slants at a downwards angle.

13. The apparatus of claim 4 further comprising a stationary rigid backing plate disposed immediately adjacent and behind the portion of the circulating belt adjacent the chute and opposite the airflow inlet.

14. The apparatus of claim 13 further comprising a plurality of apertures formed in the rigid backing plate that are configured to allow said airflow to pass through the rigid backing plate.

15. The apparatus of claim 4 wherein the blower generates said airflow by blowing air through the chamber towards the portion of the circulating belt that is disposed adjacent the chute, or by suctioning air from the chamber through the airflow outlet.

16. A belt apparatus for use on a circulating debris-removal apparatus that has rollers around which the belt apparatus circulates, an airflow flowing into a first side of the debris-removal apparatus through the circulating belt apparatus and out of a second side of the debris-removal apparatus through the circulating belt apparatus, and a debris-contaminated stream of flowable material that falls due to gravity adjacent the first side of the debris-removal apparatus such that debris falling with the flowable material is carried away from the flowable material by the airflow and into contact with the belt apparatus and is then carried away from the belt apparatus by the airflow on the second side of the debris-removal apparatus, the belt apparatus comprising:
a flexible belt surface formed into a closed loop and configured for placement on and for circulation about the rollers;
a plurality of elongate fingers extending outwards from an outward-facing surface of the circulating belt surface and disposed across substantially the entire outward-facing surface of the circulating belt surface;
a plurality of apertures formed in the circulating belt surface between adjacent elongate fingers that are configured to allow at least a portion of the airflow to pass through the circulating belt surface.

17. The belt apparatus of claim 16 wherein the elongate fingers are flexible.

18. The belt apparatus of claim 16 wherein the elongate fingers have a stepped or tapering cross section, with a widest cross section immediately adjacent an outward-facing surface of the circulating belt surface and a thinnest cross section at a tip of each of the plurality of elongate fingers.

19. A method for removing debris from a debris-contaminated stream of flowable material, the method comprising the steps of:
A. providing a debris separation apparatus having: a chamber with a material inlet, a chute having a portion extending below the material inlet to a material outlet, a blower for generating airflow, an airflow inlet, an airflow outlet, and a circulating belt that is configured so that it moves through at least a first position that is disposed in the chamber adjacent the chute and a second position that is disposed in the chamber adjacent the airflow outlet;
B. feeding a stream of debris-contaminated flowable material into the chamber via the material inlet such that at least a portion of the flowable material falls through the chute and out of the chamber via the material outlet;
C. while the flowable material is falling through the chute, operating the blower to provide the airflow so that the airflow (i) enters the chamber via the airflow inlet, (ii) is directed across the chute and through the falling flowable towards the portion of the belt disposed adjacent the chute such that debris entrained with the stream of flowable material is blown out of the stream of falling flowable material and into contact with the belt, and (iii) exits the chamber via the airflow outlet;
D. with the belt, capturing debris blown into contact with the belt by the airflow;
E. circulating the belt to carry captured debris to the portion of the belt adjacent the airflow outlet;
F. using the airflow, blowing captured debris located adjacent the airflow outlet out of the chamber via the airflow outlet.

20. The method of claim 19 further comprising the step of, after Step C(ii) and prior to Step C(iii), directing the airflow through the belt at the first position located adjacent the chute via a plurality of apertures formed in the belt then through a plurality of apertures formed in the belt at the second position adjacent the airflow outlet.
